(19) United States
(12) Patent Application Publication
(10) Pub. No.: US 2026/0259548 A1
(43) Pub. Date: Sep. 3, 2026

(54) MANUFACTURING CONTROL AND MONITORING FOR AUTOMATED SOLAR INSTALLATION

(71) Applicant: Terabase Energy, Inc., Berkeley, CA (US)

(72) Inventors: Peter Thomas May-Ostendorp, Durango, CO (US); Allan Daly, Albany, CA (US); Anna Katherine Carrigan, Fort Collins, CO (US); Eric Daniel Thompson-Martin, Los Angeles, CA (US); Rory Joseph Timar, Daly City, CA (US); Upadhi Vijay, Berkeley, CA (US); Adam Hansel, Davis, CA (US); Soren Jensen, Corte Madera, CA (US); Matthew Paul Campbell, Berkeley, CA (US)

(73) Assignee: Terabase Energy, Inc., Berkeley, CA (US)

(21) Appl. No.: 19/364,279

(22) Filed: Oct. 21, 2025

Related U.S. Application Data
(63) Continuation-in-part of application No. 19/067,037, filed on Feb. 28, 2025.

(51) Int. Cl. G05B 19/4155; B60P 3/00; B66F 9/06; B66F 9/065; B66F 9/16; H02S 10/40

(52) U.S. Cl. CPC G05B 19/4155; B60P 3/00; B66F 9/063; B66F 9/0655; B66F 9/16; H02S 10/40; G05B 2219/31372

(57) ABSTRACT

A large solar farm comprises one or more solar arrays, each with hundreds of rows of solar modules. Construction of a solar farm is a process that involves a large amount of human effort and coordination for solar table assembling and installation. The present invention discloses various embodiments for solar table manufacturing and installation monitoring and control. Solar tables are assembled at a centralized factory according to build orders placed via a manufacturing execution system. Assembled solar tables are transported by mobile transport or trailers to or near point of installation and then transferred to lander vehicles for installation. Implementation of the invention integrates coordinated solar table assembling, transporting, transferring, and installation for large solar installation projects.

### CROSS-REFERENCE TO RELATED APPLICATIONS

This application is a continuation-in-part of U.S. Patent Application No. 19/067,037 (Docket No. 20179-2786US), filed on February 28, 2025, entitled “MANUFACTURING CONTROL AND MONITORING FOR AUTOMATED SOLAR INSTALLATION”, and listing Peter May-Ostendorp, Allan Daly, Anna Carrigan, Eric Thompson-Martin, Rory Timar, Upadhi Vijay, Adam Hansel, and Soren Jensen as inventors. The aforementioned patent document is incorporated by reference herein in its entirety.

### TECHNICAL FIELD

The present disclosure relates generally to solar power plant installation. More particularly, the present disclosure relates to manufacturing control and monitoring to improve installation efficiency for large solar plants.

### BACKGROUND

The importance of solar power systems is well understood by one of skill in the art. Government agencies and companies are scaling the size and number of solar solutions within their energy infrastructure. This transition from traditional fossil fuel energy systems to solar energy solutions presents several challenges. One challenge is the ability to improve on-site installation efficiency, quality, and safety during the installation process of a large amount of solar modules. Such a process typically involves labor-intensive work that requires a large amount of human effort for solar table assembling and installation.

FIG. 1 shows a typical solar farm 105 comprising an array of installed solar structures 110, e.g., solar tables. Each solar structure comprises multiple solar modules 115. A large-scale solar farm typically includes hundreds of thousands of solar modules that are located across a multi-hundred-acre terrain and that are electrically coupled to provide a source of energy. In a typical installation process, multiple solar modules are securely aligned and attached to a metal structure (purlins or torque tube) to form a row of solar modules. A solar farm may comprise one or more solar arrays, with each solar array having hundreds of rows of solar modules. A row of solar modules may be supported by supporting structures (e.g., ground piles, ground screws, ballasted foundations, etc.) with the metal structure securely fastened to supporting structures at a desired rotational angle such that the solar modules are oriented for maximum energy production efficiency.

Large-scale systems are often located in remote areas and involve complex management of materials, resources, logistics, labor, etc. It is very desirable to implement manufacturing control and monitoring for improved installation efficiency, assembly quality, and safety during the installation process.

What is needed are systems and methods of manufacturing control and monitoring to improve efficiency, safety, and quality for large solar installation projects.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that the description is not intended to limit the scope of the invention to these particular embodiments. Items in the figures may be not to scale. Functionally identical parts may be labeled with the same reference numeral.

FIG. 1 depicts a general layout of a large-scale solar site.

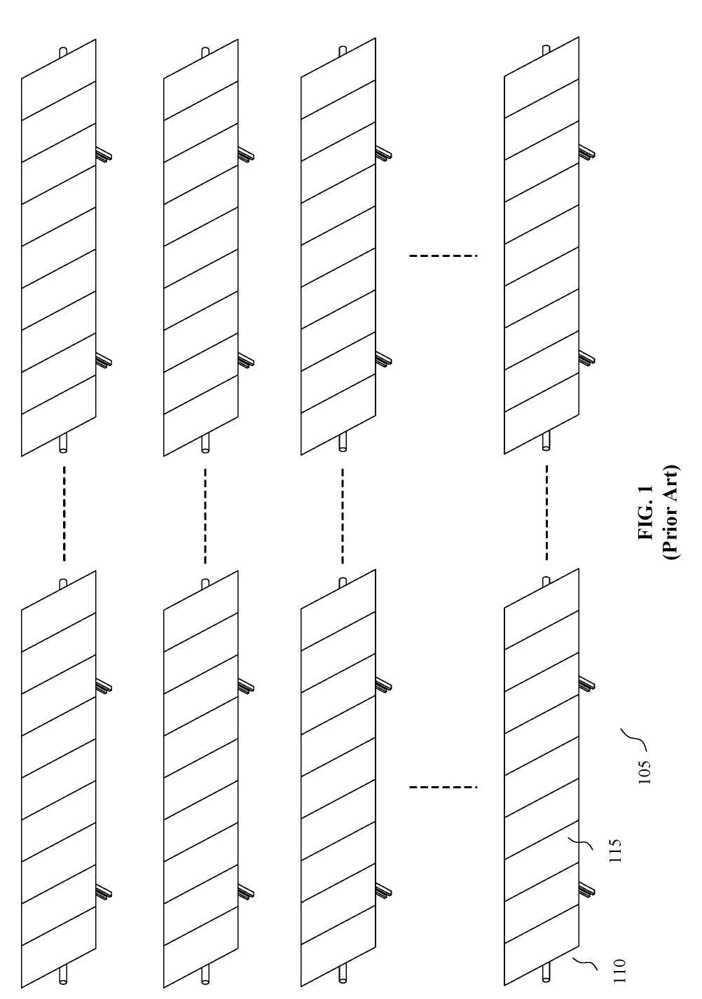

FIG. 2A depicts a distributed construction process for solar module installation.

FIG. 2B depicts a centralized solar table assembly and installation for large-scale solar systems in accordance with various embodiments of the invention.

FIG. 3 depicts a system diagram for solar table manufacturing and installation monitoring and control in accordance with various embodiments of the invention.

FIG. 4 depicts an interactive interface for installation monitoring and control in accordance with various embodiments of the invention.

FIG. 5 depicts an enlarged interactive interface for installation monitoring and control in accordance with various embodiments of the invention.

FIG. 6 depicts an interface showing a detailed status for a selected solar table in accordance with various embodiments of the invention.

FIG. 7 depicts an interface showing a bill of materials (BOM) summary in accordance with various embodiments of the invention.

FIG. 8 depicts an interface showing a production summary in accordance with various embodiments of the invention.

FIG. 9A depicts a comprehensive interactive interface with real-time updates for solar table manufacturing, delivering, and installation monitoring and control in accordance with various embodiments of the invention.

FIG. 9B depicts another comprehensive interactive interface with real-time updates for solar table manufacturing, delivering, and installation monitoring and control in accordance with various embodiments of the invention.

FIG. 9C depicts a solar table transferring from a mobile transport or a solar table trailer to a lander vehicle in accordance with various embodiments of the invention.

FIG. 9D depicts a forklift-based lander vehicle in accordance with various embodiments of the invention.

FIG. 10A depicts a process for solar table manufacturing and installation monitoring in accordance with various embodiments of the invention.

FIG. 10B depicts multiple steps for solar table manufacturing and installation monitoring in accordance with various embodiments of the invention.

FIG. 10C depicts steps for solar table transferring in accordance with various embodiments of the invention.

FIG. 11 depicts a configurable factory production interface with solar-table manufacturing queue rank in accordance with various embodiments of the invention.

FIG. 12 depicts an installation swap in an interactive interface for installation monitoring and control to adjust installation planning in accordance with various embodiments of the invention.

FIG. 13 depicts a process for solar table installation swap in accordance with various embodiments of the invention.

FIG. 14 depicts a simplified block diagram of a computing device/information handling system in accordance with various embodiments of the present disclosure.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method.

Components, or features, shown in diagrams are illustrative of exemplary embodiments of the invention and are meant to avoid obscuring the invention. It shall also be understood that throughout this discussion, components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components in a system for tracking and managing production, productivity, safety and quality on large projects, such as the construction of a large-scale solar farm.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A component, function, or structure is not limited to a single component, function, or structure; usage of these terms may refer to a grouping of related components, functions, or structures, which may be integrated and/or discrete.

Further, it shall be noted that: (1) certain components or functionals may be optional; (2) components or functions may not be limited to the specific description set forth herein; (3) certain components or functions may be assembled/combined differently; and (4) certain functions may be performed concurrently or in sequence.

In this document, “large-scale solar system” or “large solar projects” is defined as a solar system or project involving installation and/or operation of 1000 or more solar modules. The word “resources” refers to material, parts, components, equipment or any other items used to construct a solar table and/or solar system. The term “solar table” is defined as a structural assembly comprising one or more photovoltaic (PV) or solar modules and/or one or more module frames (or purlins) for module support. Some types of solar tables may have electrical harnesses and supplemental structures that allow them to connect to other solar tables or foundations/piles while other types do not have this supplemental structure. The term “torque tube” is defined as a structural component that supports multiple solar modules with proper alignment. Torque tubes are often part of tracking systems for optimal sunlight capture for solar modules. The term “mobile transport” or “rover” is defined as a specifically designed vehicle to transport solar tables from the centralized solar table assembly factory for on-site installation or on-site storage. The mobile transport may be driven by personnel, controlled by remote control, or autonomously driven by a computer system. The term “tracker” or “solar tracker” is defined as a device that orients one or more solar modules towards the Sun. A tracker may comprise one or more solar tables that are aligned, motors and gears to enable solar tracking movement. A tracker may also comprise microprocessors and sensors to detect Sun light direction to manage and control movement of solar tables in the tracker. A tracker may track the Sun as the Sun moves across the sky based on time and location by astrological calculations. Trackers typically follow the Sun from east to west.

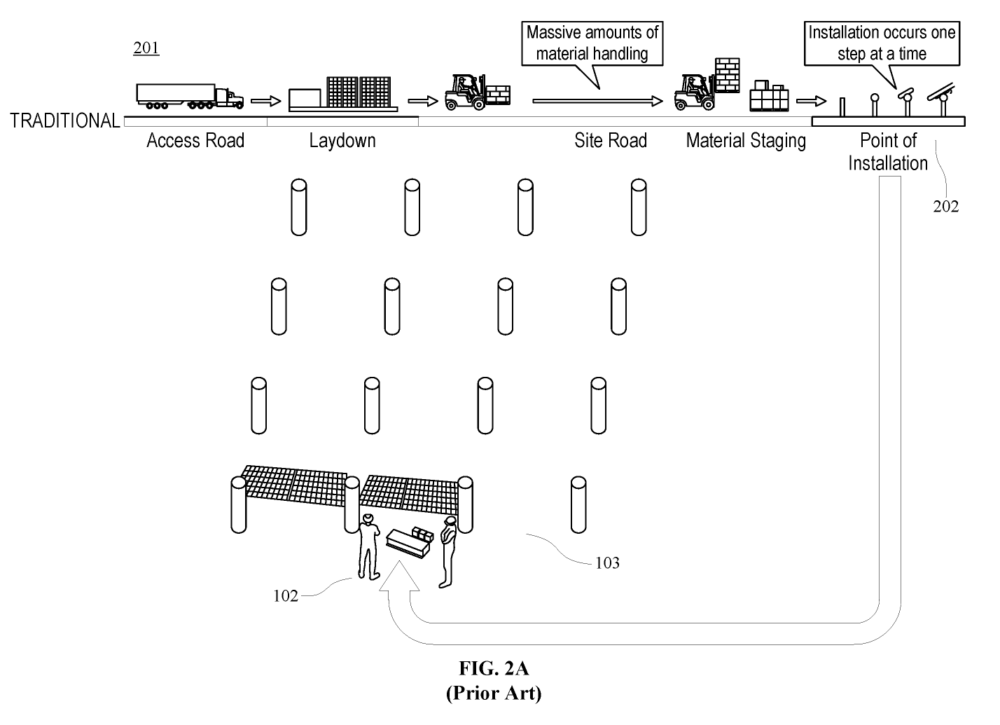

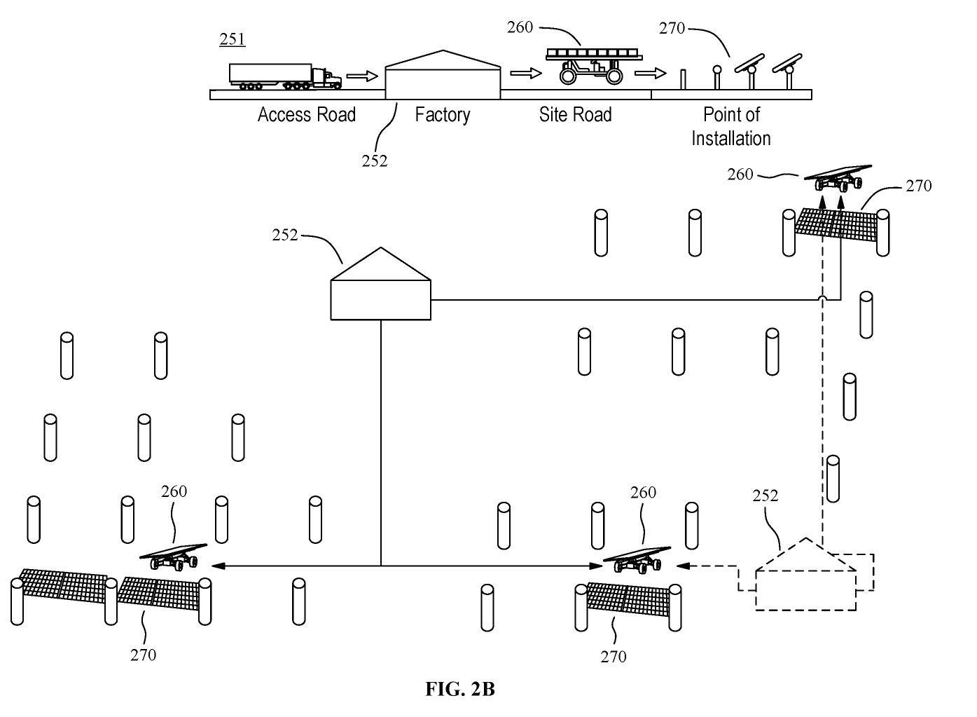

FIG. 2A depicts a distributed construction process for solar module installation. The installation process 201 is implemented such that all mounting equipment for each solar panel is individually assembled and installed at its location 202 within the larger system. Such traditional deployment relies on materials being delivered to a deployment site via an access road. The materials are then processed and staged at the deployment site by a crew. A small portion of this delivered material is then moved by heavy equipment to a specific location where a solar panel and mounting equipment are assembled and installed at an installation location. The step is then repeated for an adjacent installation location where materials are subsequently delivered, assembled and installed for a neighboring solar table within the system. For a large solar system, such an installation process becomes costly and has challenges of consistency and reliability of the entire installation process.

FIG. 2B depicts a centralized solar table assembly and installation for large-scale solar systems according to various embodiments of the invention. Resources are brought to a construction site 251 for a large-scale solar system. These resources are delivered, directly or after initial processing, to one or more assembly factories 252 where a coordinated and centralized solar table assembly process is performed. Some types of solar panels may have electrical harnesses and supplemental structures that allow them to connect to other solar panels or foundations/piles while other types do not have this supplemental structure. Assembled solar tables and equipment are moved from an assembly factory 252 to a point of installation 270 via motorized vehicles (also referred to as mobile transports) 260. The approach of utilizing centralized and coordinated assembly factories may allow a more cost-effective and dynamic process of constructing large-scale solar systems.

### A. System Embodiments for Solar Table Manufacturing and Installation Monitoring and Control

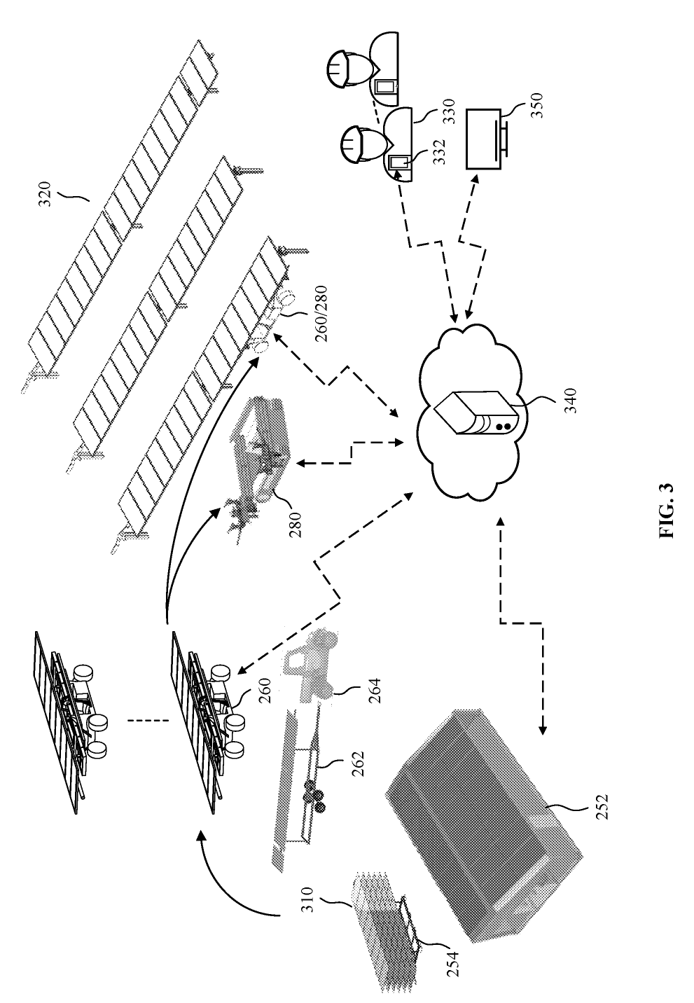

FIG. 3 depicts a system diagram for solar table manufacturing and installation monitoring and control according to various embodiments of the invention. A server 340 is communicatively coupled to various components, including but not limited to one or more centralized assembly factories 252, a table storage 254 for storing assembled solar tables 310, one or more mobile transports 260 for transporting solar tables from the assembly factory 252 (or the solar table storage 254) to the installation site 320, a portable electronic device 332 held or worn by an on-site personnel 330 (e.g., a mobile transport driver or an on-site installer). The solar storage 254 may be a solar table rack placed in proximity to or within the centralized assembly factory 252. It should be noted that the mobile transport 260 may both transport one or more solar tables 310 to the installation site 320 and handle the installation directly. Alternatively, the mobile transport 260 may just transport one or more solar tables 310 to or near the installation site 320 and transfer one or more solar tables 310 to a lander vehicle that handles solar table installation. In this approach, the mobile transport 260 may focus on solar table transportation only and therefore may be configured more easily to be an autonomous driving vehicle for transportation tasks to achieve higher efficiency and lower workforce requirements. Furthermore, the mobile transport vehicle handles solar table transportation with or without an actuation system to lift a solar table above adjacent piles or already installed tables and/or to help facilitate the transloading to the lander vehicle. In one or more embodiments, the lander vehicle may be a telehandler 280 with a customized end of arm tool that facilitates multi degrees of freedom manipulation of the preassembled solar table for final installation. The mobile transport and the lander vehicles can be operated by a human, remote control and autonomously completely or some combination thereof.

It should be noted that the solar tables 310 may also be transported to or near an installation site by a solar table trailer (hereinafter “trailer”) 262 other than a mobile transport 260. The trailer may be towed by a tow vehicle 264, e.g., an all-terrain vehicle (ATV), a utility task vehicle (UTV), an agricultural tractor, a general utility truck (e.g., a pick-up), etc., and may have one or more axles to support load weight partially or entirely. The trailer may or may not provide alignment capability for desired vertical, horizontal, and/or angular motions for a torque tube and/or solar table. The movement may be a manual or motorized motion.

The server 340 receives information from all above-mentioned components for processing and generates one or more interactive interfaces to be rendered on a terminal device 350 for an authorized user (e.g., a project manager) to monitor and control. The server 340 may also be communicatively coupled with other equipment for device tracking and management. The server 340 may be deployed on-site or be a cloud server accessible remotely by the terminal device 350 (e.g., a workstation, a desktop, a laptop, a tablet, etc.). The assembly factory 252 may be equipped with various terminals, e.g., cameras, touch screens, scanners, etc., such that the assembling progress of a solar table may be communicated, automatically or manually by assembling staff, in real-time to the server. A mobile transport 260, a solar table trailer 262, and/or a tow vehicle 264 may be equipped with various sensors, e.g., a pressure or proximity sensor and a Global Positioning System (GPS) sensor, such that the server 340 may track the real-time status (loaded or unloaded) and location of the mobile transport. An on-site installer may use a portable electronic device 332 to communicate to the server 340 for updates when a solar table is installed successfully. Such updates may also be performed automatically by a lander vehicle which provides a location and a table ID to the main server to validate and record a successful installation of a solar table. The manufacturing and installation status may be monitored via the interactive interface rendered on the terminal device 350 and be configurable for manufacturing and installation adjustment based on the monitored status.

### B. Interactive Interface Embodiments for Solar Table Manufacturing and Installation Monitoring

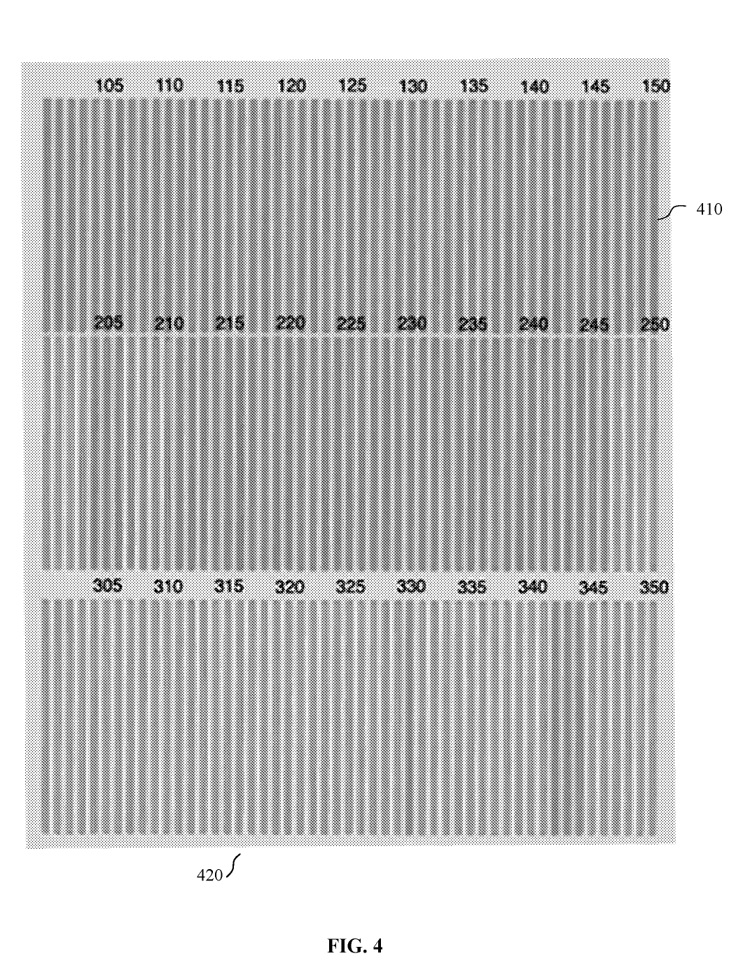

FIG. 4 depicts an interactive interface for installation monitoring and control in accordance with various embodiments of the invention. The interactive interface comprises a digital installation field 420 that is a digital representation of the actual installation site 320. The digital installation field 420 comprises multiple rows of digital trackers 410 that correspond to actual trackers. Digital trackers may be marked differently for different statuses (installed, partially installed, delivered, planned, etc.). Other tracker statuses could be “blocked” indicating that the tracker or table(s) can’t be installed due to one or more conditions, e.g., a trench for underground electrical cabling, other construction tasks being undertaken in the vicinity, an area been deemed inaccessible due to flooding, mud, presence of protected species or cultural artifacts, etc. Each digital tracker is associated with a tracker number for identification.

The digital installation field 420 is zoomable for a more detailed view or a more comprehensive view. It may be initialized from a design template or from an on-site scanning when infrastructure construction of solar table supporting piles is completed. The digital installation field 420 is initialized to comprise multiple solar table representations that correspond to solar tables to be installed. The digital installation field 420 may be updated automatically or manually in real time as the solar table installation process goes on.

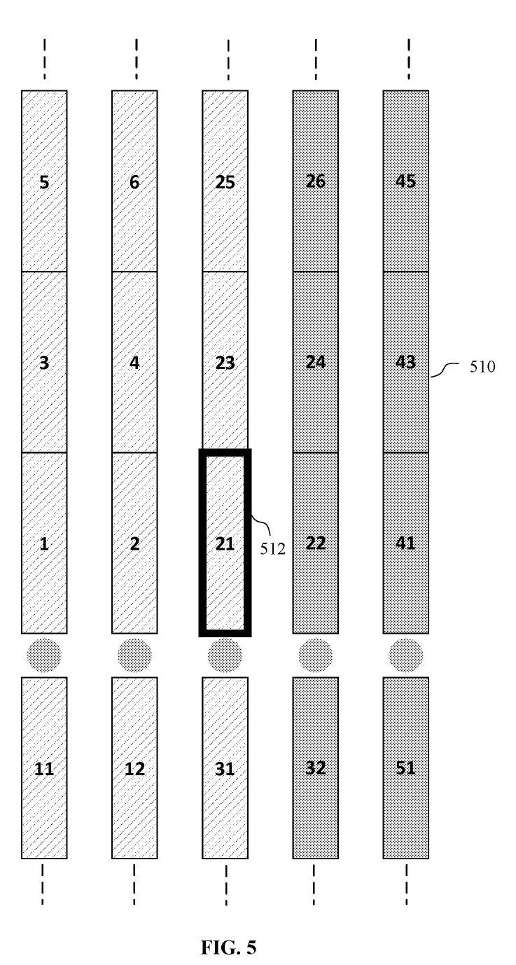

FIG. 5 depicts an enlarged interactive interface for installation monitoring and control in accordance with various embodiments of the invention. As shown in FIG. 5, each digital tracker comprises a plurality of solar table representations 510 that may be marked differently for different statuses. For example, a color coding may be used to mark the solar tables for different statuses. As shown in the exemplary embodiment in FIG. 5, a light grey may be used to identify installed solar tables, while a pattern fill is used for planned but not installed solar tables. For additional information, a user may select one or more solar table representations 512, which may be highlighted (brighter, darker, having thicker edges, enlarged, etc.) for selection identification.

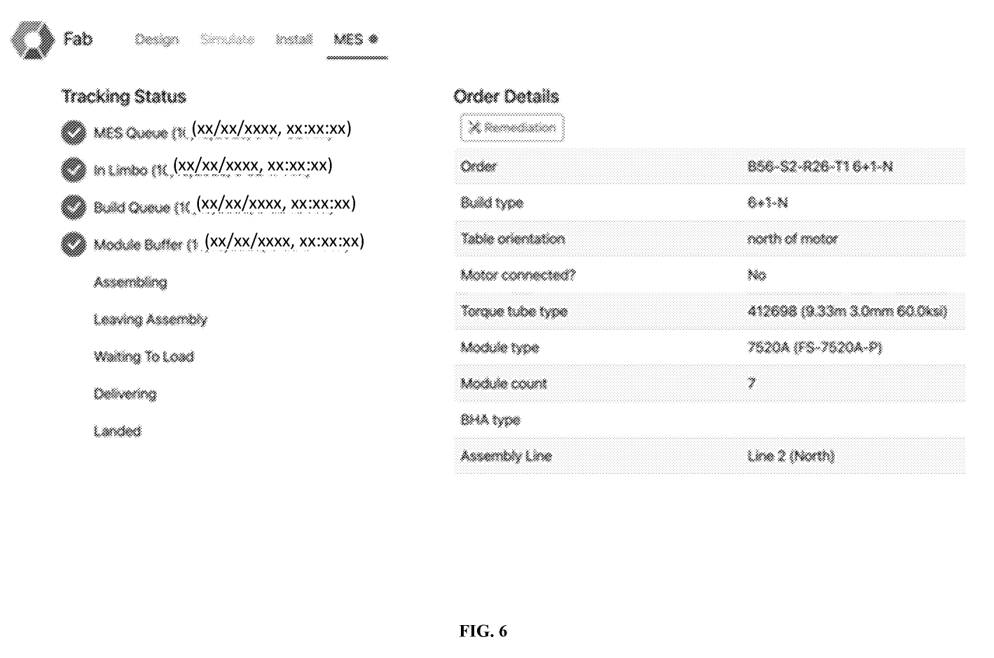

FIG. 6 depicts an interface showing a detailed status for a selected solar table in accordance with various embodiments of the invention. The solar table status interface displays information such as order details and tracking status. The order details show configuration of the solar table, specification of a torque tube, numbers/types of solar modules, and other build design characteristics stored in the digital field representation on the server. The tracking status shows information of manufacturing and delivery events, which may include a list of executed events and a list of ongoing events to be executed. For example, the event may include the time of an order for the solar table created or received in a manufacturing execution system (MES), the time the solar table entered a build queue, the time the solar table completed assembling or expected to finish assembling, the time the solar table loaded or scheduled to be loaded onto a solar table storage (the solar table storage 254) or a mobile transport 260, etc. An MES is a software-based system that manages a manufacturing and assembling process for solar tables at the one or more centralized factories and tracks logistics for parts involved in solar table assembly. The MES may provide real-time data for production efficiency, quality, and delivery. The MES may manage one or more solar table assembly line and has information of how each assembly line is configured. The MES may be configured to send solar table assembling orders/tasks to assembly lines that have the parts to build them only. For an installed solar table, the solar table status interface displays a comprehensive manufacturing, delivery, and installation history. For a planned solar table, the solar table status interface displays information on events history and events to be filled such that a user may have a comprehensive view of the current status.

In one or more embodiments, the MES is built so that assembly order or tasks can be done at one or more assembly lines, which may be configured to fulfill orders for a dedicated workfront, referred to as specific rows (e.g., typically 1-5 rows) where the solar tables being assembled, or multiple workfronts. A single factory (line) can supply tables to one or multiple workfronts. Similarly, rovers or mobile transports may be paired to specific individual assembly lines, be allowed to return to any assembly lines, or be dynamically changed depending on the overall installation process. Such flexibility and configurability further enhance efficiency for manufacturing and installation management.

In one or more embodiments, the mobile transport 260 may incorporate a terminal device, e.g., a touch screen, to render an interactive driver interface that displays information comprising one or more of the current location of the mobile transport 260, information about a solar table when the mobile transport is loaded, a destination for the solar table, status of the mobile transport, a returning location after unloading, information about a subsequent solar table to be loaded, etc. When multiple assembly lines are utilized for solar table assembly, the driver interface displays the assembly line where the mobile transport returns. The driver interface may also receive input from a driver so that the server may be informed when any unexpected incident (e.g., unexpected vehicle breakdown or road blockage) happens.

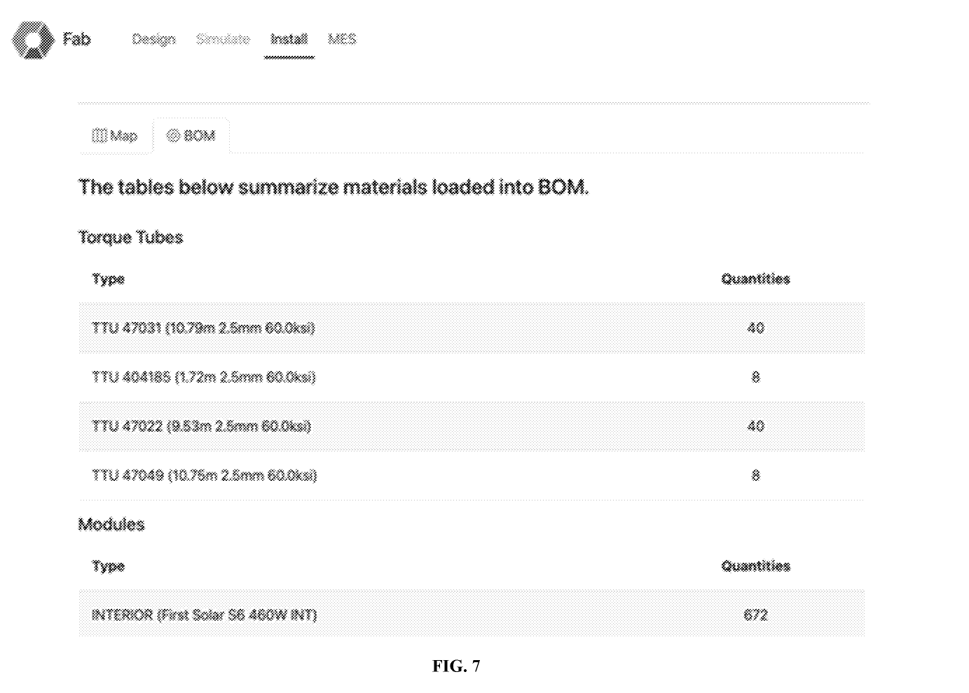

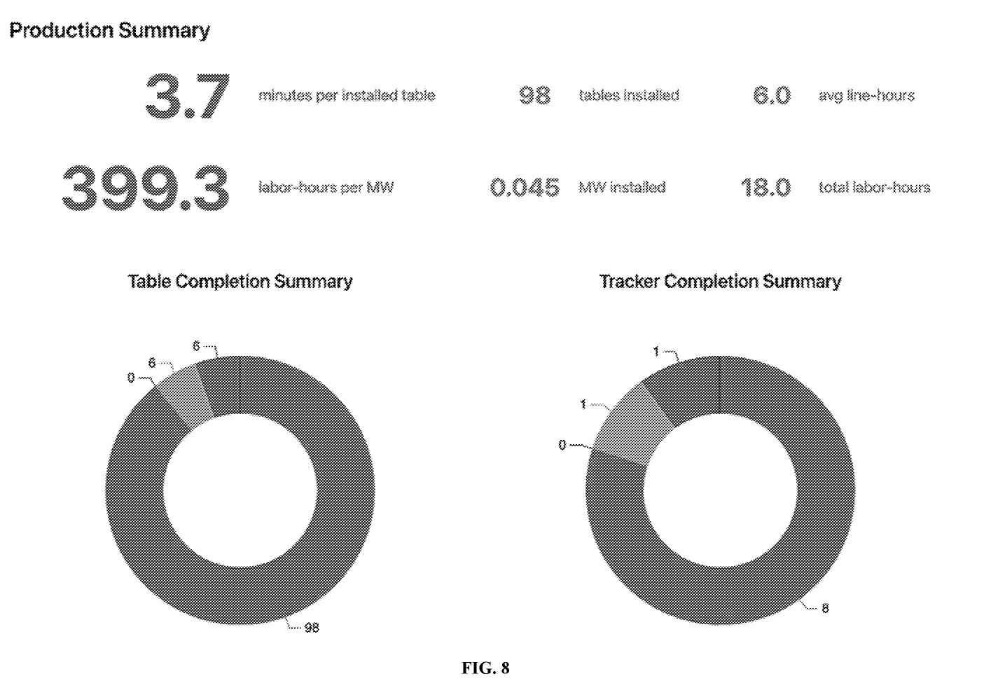

Besides the aforementioned interfaces for installation monitoring and control, the server 340 may render an interface for summary information. FIG. 7 depicts an interface showing a bill of materials (BOM) summary in accordance with various embodiments of the invention. A BOM is a comprehensive list detailing all components (e.g., torque tubes, bearing housing assemblies (BHAs), module rails, fasteners and solar modules), types, and quantities needed for a complete assembled solar system. FIG. 8 depicts an interface showing a production summary in accordance with various embodiments of the invention. The production summary interface textually and graphically shows a solar table completion summary and a tracker completion summary.

### C. Real-time Interface Embodiments for Solar Table Manufacturing, delivering, and Installation Monitoring and Control

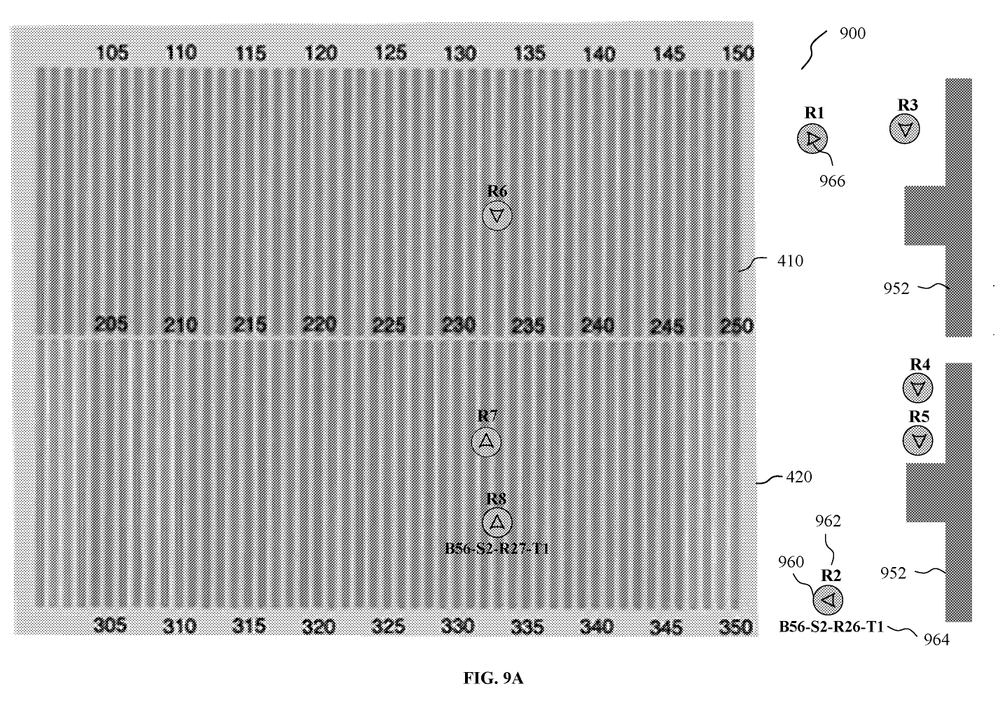

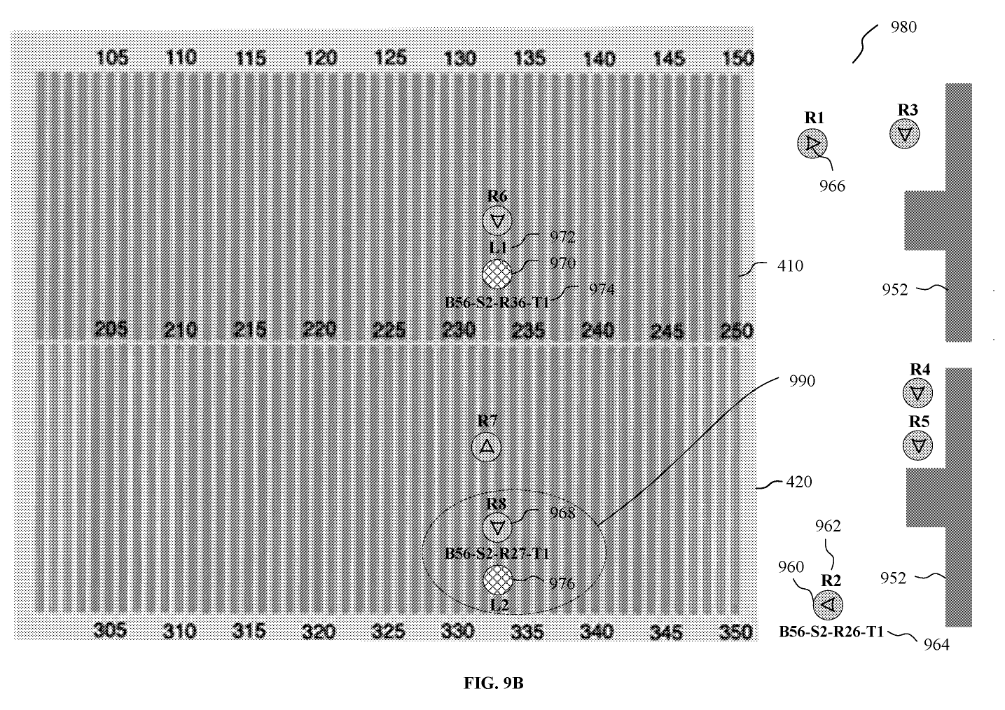

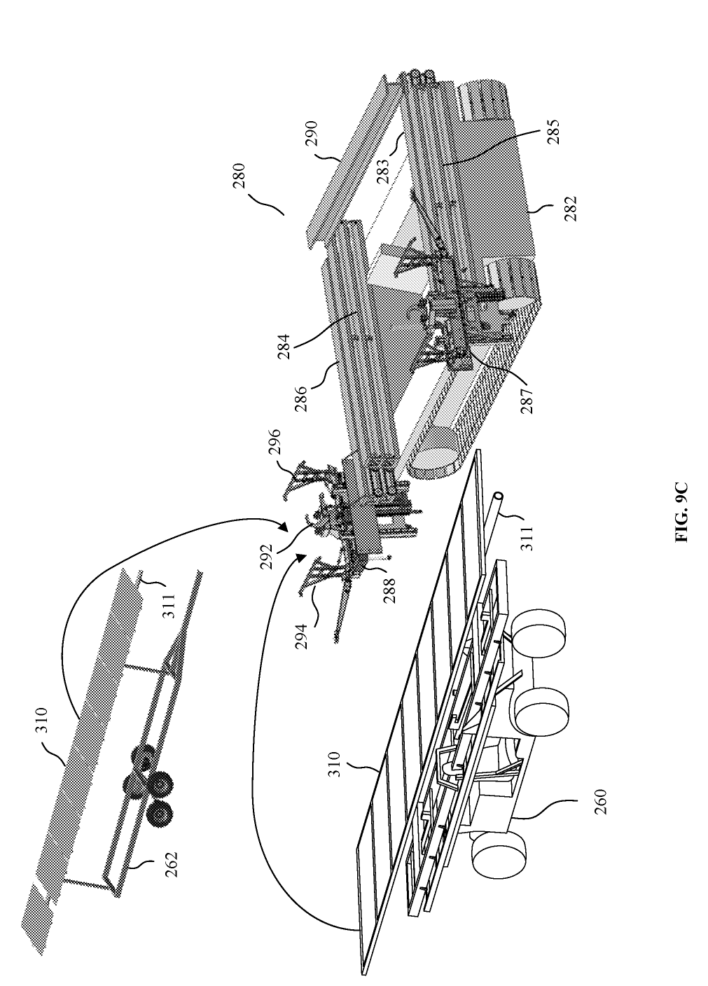

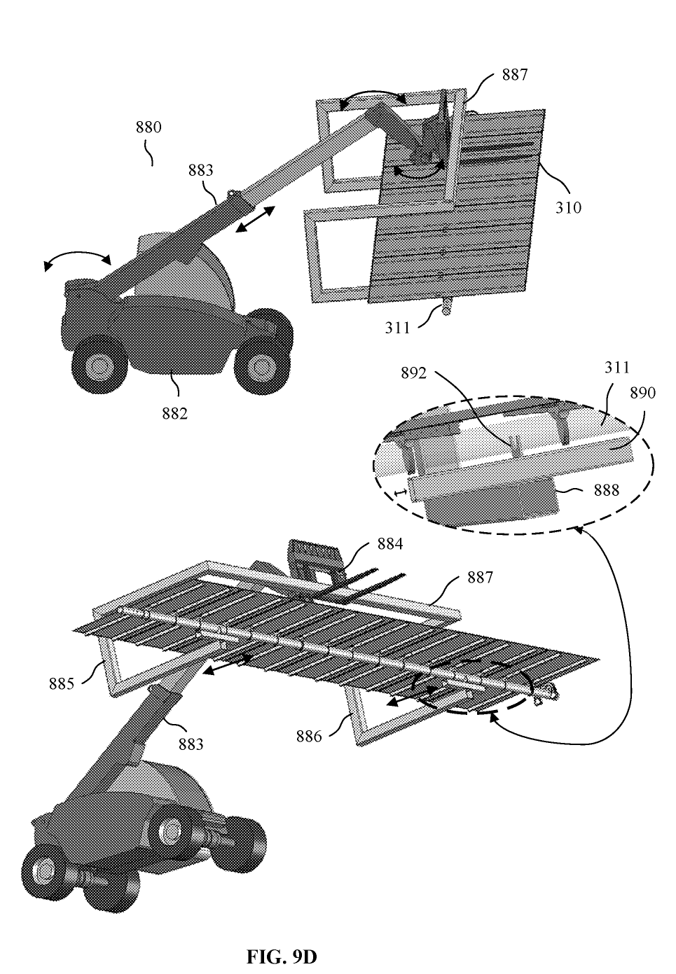

In one or more embodiments, the server 340 may render a comprehensive interactive interface with real-time updates for solar table manufacturing, delivering, and installation monitoring and control, as shown in FIG. 9A. The comprehensive interactive interface 900 comprises the digital installation field 420 described above, one or more centralized assembly factory representations 952, and one or more transport representations 960.

Each transport representation may be associated with a transport ID 962 (e.g., R2, which represents a mobile transport or rover #2) corresponding to a mobile transport (or a solar table trailer) and optionally a solar table ID 964 (e.g., B56-S2-R26-T1) if the mobile transport is loaded with a solar table. Once the solar table is unloaded, the solar table ID 964 is detached from the transport representation 960. Alternatively, the transport representation 960 may be marked differently (e.g., with different colors) to differentiate a loaded or unloaded status. The transport representation 960 may also be configured to display a movement direction via a movement icon 966 attached to the transport representation 960. The movement icon 966 may be an arrow icon, as shown in FIG. 9A, to point to the direction of the mobile transport movement. The mobile transports may be equipped with tracking sensors (e.g., GPS sensors) for location/speed tracking. Accordingly, transport representations 960 may also be dynamically displayed on the comprehensive interactive interface with a refresh rate default set or adjustable by an authorized user depending on network connection parameters (latency, traffic amount, etc.).

Once a mobile transport loads a solar table from a centralized factory directly or from a solar table storage near the centralized factory, the status of the corresponding transport representation is also updated (automatically by sensors placed on the mobile transport, or manually by a driver of the mobile transport, and/or manually by a loading staff at the centralized factory) in the comprehensive interactive interface. Such a status update may be realized by a color change of the transport representation and/or a solar table ID attached (or displayed) next to the transport representation. At the same time, the status of the solar table is updated to include an event of solar table loading, which includes information of a time of the loading event and a transport ID of the mobile transport receiving the solar table.

Once the mobile transport unloads the solar table for installation, the transport representation is updated again (automatically by sensors placed on the mobile transport, or manually by a driver of the mobile transport, and/or manually by an on-site installation staff) in the comprehensive interactive interface. Upon completion of installation, the status of the solar table is updated to include an event of solar table installation, which includes the table location in the field, the time of the installation event and a crew or an installer who handles the installation. In one or more embodiments, when a mobile transport breaks down, its transport representation may be updated into a fault status represented by a red mark, a flashing mark, etc., on the comprehensive interactive interface for user attention and delivery/installation plan adjustment (e.g., dispatching a service crew to correct transport failure). The field foreman or factory foreman can modify the production/delivery schedule accordingly to mitigate the impact of the disabled transport vehicle and associated table enroute to the point of installation.

FIG. 9B depicts another comprehensive interactive interface with real-time updates for solar table manufacturing, delivering, and installation monitoring and control in accordance with various embodiments of the invention. Similar to the comprehensive interactive interface 900 shown in FIG. 9A, the comprehensive interactive interface 980 in FIG. 9B comprises the digital installation field 420, one or more centralized assembly factory representations 952, and one or more transport representations 960~968. In the embodiment shown in FIG. 9B, each transport representation corresponds to a mobile transport or a solar table trailer that handles solar table transportation from the centralized assembly factory 952 to or near an installation site for solar table transferring to a lander vehicle, which is presented by a corresponding lander representation 970 or 976.

Similar to transport representations, each lander representation may be associated with a lander ID 972 (e.g., L1, which represents a lander vehicle #1) corresponding to a lander vehicle. A lander representation may be optionally associated to a solar table ID 974 (e.g., B56-S2-R36-T1) if the lander vehicle is loaded with a solar table transferred from a mobile transport or a trailer. The lander representation 970 may be marked differently (e.g., with different colors) to differentiate a loaded or unloaded status.

In one or more embodiments, when a solar table is in the middle of transferring from a mobile transport (or a trailer) to a lander vehicle, the transport representation e.g., 968, and the lander representation 976 may be enclosed by a transferring representation 990 to indicate an active solar table transferring process. The transferring representation 990 may be rendered in a colorful enclosure that is flashing. Alternatively, the transport representation 968 and the lander representation 976 may flash together without the transferring representation 990 to indicate active transferring process. Once the active solar table transferring process is completed, the flashing stopped and the solar table under transferring is disassociated from the transport representation 968 and associated with the lander representation 976.

FIG. 9C depicts a solar table transferring from a mobile transport or a solar table trailer to a lander vehicle in accordance with various embodiments of the invention. The lander may be a modified telehandler with an end of arm tool that facilitates multiple degrees of freedom manipulation of the table during the installation process. In other embodiments the lander can be a rover dedicated to the landing function.

The lander 280 picks up solar table 310 from the mobile transport 260 or the solar table trailer 262. The lander 280 comprises a base vehicle 282, a pair of support rails 283/284 attached to the base vehicle 282, a pair of sliding rails 285/286 slidably attached to respective support rails, a pair of vertical motion elements 287/288 attached to the pair of sliding rails respectively for vertical movement. The support rails 283/284 may be connected via one or more coupling frames 290 for structural robustness. The sliding rails and the vertical motion elements enable the lander 280 horizontal and vertical adjustability to fetch the solar table during a solar table transferring process and to install the solar table during a solar table installation process. Each sliding rail may be operated independently for a desired horizontal position and a yaw angle during solar table transferring or installation. Similarly, each vertical motion element may be operated independently for a desired vertical position and a pitch angle during solar table transferring or installation.

A torque tube engaging element, such as a tube hook 292 may be deployed on each vertical motion element to hold a torque tube 311 of the solar table 310 securely during the solar table transferring and installation process. A pair of anti-rotational wings 294/296 may be placed on both sides of the tube hook 292 to provide stable and secure support for the solar table during the transferring or installation process. In one or more embodiments, each vertical motion element may further incorporate a rotational movement element, e.g., a motorized roller, such that the solar table 310 may be rotated the to a desired rotation angle for installation when the solar table 310 is held by the lander 280.

After the lander 280 takes possession of the solar table 310, the mobile transport 260 or the solar table trailer 262 returns to the factory to pick up a new solar table. After the lander 280 completes the installation of the solar table 311, the lander 280 moves to a new point of installation and is ready for a subsequent solar table transferring. The mobile transport 260 and the lander 280 may be structurally different with the mobile transport having no or limited adjustability of the loaded solar table. Alternatively, the mobile transport 260 and the lander 280 may be similar in structure for horizontal, vertical and/or rotational adjustability of the loaded solar table.

FIG. 9D depicts a forklift-based lander vehicle in accordance with various embodiments of the invention. The lander vehicle 880 has a vehicle base 882, an extendable arm 883 having a proximal arm end pivotably attached to the vehicle base 882, a fork carriage 884 that comprises a pair of forks and is pivotably coupled to a distal end of the extendable arm 883, an extension beam 887 supported by the pair of forks, a pair C-beams 885/886 coupled respectively to opposite ends of the extension beam 887. Each C-beam has a lower beam arm 888 supporting a holding bar 890 that attaches one or more torque tube couplers 892, as shown in the detailed view in which the torque tube 311 is rendered semi-transparent for view clarity. The lower beam arm 888 may be a rail such that the holding bar 890 may slide along the lower beam arm 888 to adjust a yaw angle of the torque tube (and thus the solar table) for installation.

Each torque tube coupler has an indentation that at least partially matches a cross-sectional shape of the torque tube 311 such that the torque tube 311 may be securely supported by the torque tube couplers 892. For example, the torque tube coupler 892 may have an arc-shaped indentation with a curvature matching a radius of the torque tube 311 for a tight fit. The torque coupler can also be an actuated clamp that can apply force on the torque tube and thus keep the torque tube and solar table from rotating and/or sliding during transport and/or installation.

The lander vehicle 880 may be operated to control a pivot angle and/or an extension level of the extendable arm 883, and/or a pivot angle of fork carriage 884 for desired height and depth adjustment of the C-beams to fetch the solar table 310 from the mobile transport 260 or solar table trailer 262 at or close to the point of installation, and perform final landing/installation of the solar table at the point of installation. The actuation or control of the C-beams facilitates fine adjustments that a regular forklift cannot deliver. The extension beam 887 may also be pivotably attached (e.g., via bolted connection, welded connection, rivet connection, or a combination thereof) to a distal end of the extendable arm 883 without the fork carriage. Although other types of beams and beam attachment layouts may also be applicable, the attachment of C-beams at the end of the extension beam has the advantages of providing an operator of the lander vehicle unobstructed view to observe and ensure proper installation of the solar table.

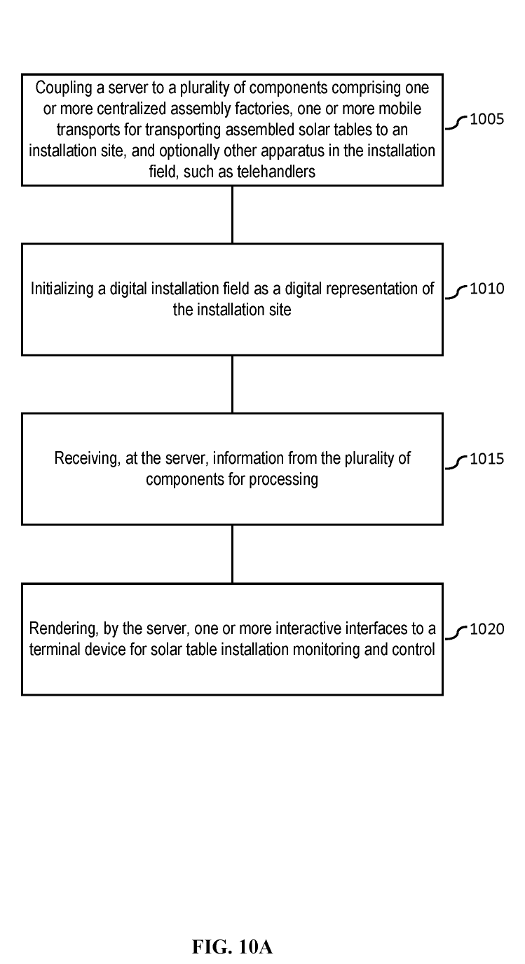

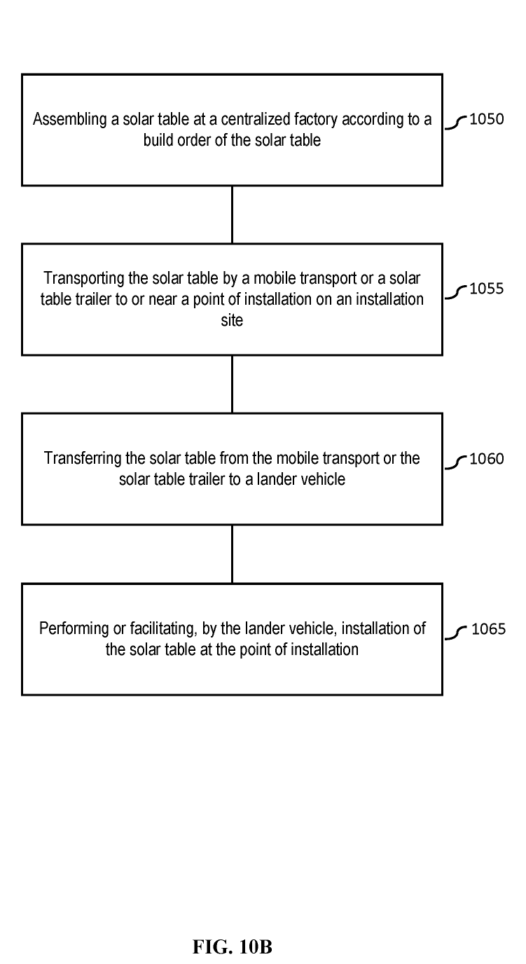

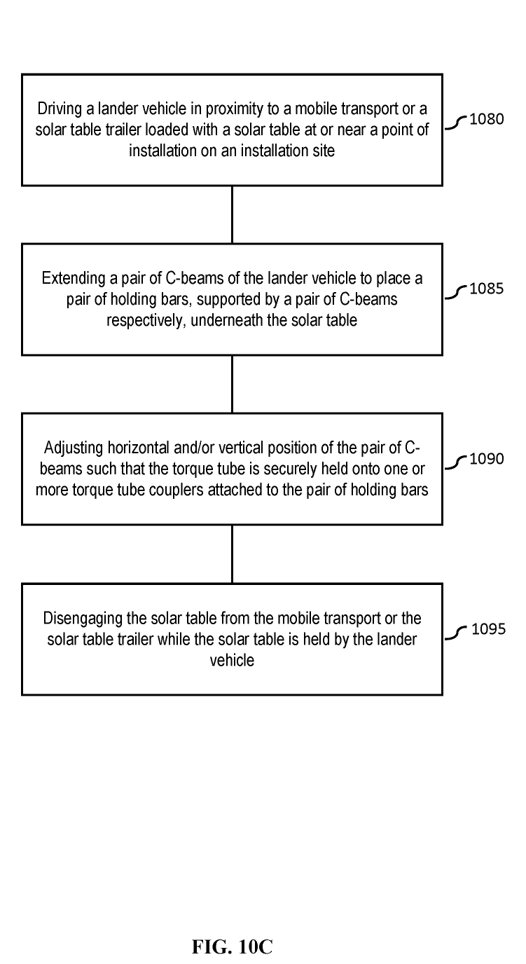

FIG. 10A depicts a process for solar table manufacturing and installation monitoring in accordance with various embodiments of the invention. In step 1005, a server is communicatively coupled to a plurality of components comprising one or more centralized assembly factories, one or more mobile transports for transporting assembled solar tables to an installation site, and optionally other apparatus in the installation field, such as telehandlers. In step 1010, a digital installation field is initialized as a digital representation of the installation site. In step 1015, the server receives information from the plurality of components for processing. In step 1020, the server renders one or more interactive interfaces to a terminal device for solar table installation monitoring and control. The one or more interactive interfaces comprise the digital installation field that is updated automatically as the solar table installation process goes on.

FIG. 10B depicts multiple steps for solar table manufacturing and installation monitoring in accordance with various embodiments of the invention. It shall be understood that One or more of the described processes may be performed autonomously or manually. In step 1050, a solar table is assembled at a centralized factory according to a build order of the solar table placed via a manufacturing execution system (MES). Status of the solar table may be tracked in the MES and may be dynamically adjusted as described in FIGS. 6-7. The solar table, upon assembling completion, comprises a torque tube and one or more solar modules attached to the torque tube. In step 1055, the solar table is transported by a mobile transport or a solar table trailer to or near a point of installation on an installation site. In step 1060, the solar table is transferring from the mobile transport or the solar table trailer to a lander vehicle. The lander vehicle may wait for the mobile transport or the solar table trailer or be coordinated to move toward the point of installation in parallel to the mobile transport or the solar table trailer. Such coordination may be implemented through a comprehensive interactive interface for solar table manufacturing, delivering, and installation monitoring and control. The mobile transport or the solar table trailer may drive back to the centralized factory to load another assembled solar table after the transferring of the solar table is completed. In step 1065, the lander vehicle performs or facilitates installation of the solar table at the point of installation.

FIG. 10C depicts steps for solar table transferring in accordance with various embodiments of the invention. In step 1080, a lander vehicle drives in proximity to a mobile transport or a solar table trailer loaded with a solar table at or near a point of installation on an installation site.

In step 1085, a lander vehicle extends a pair of C-beams to place a pair of holding bars, supported by a pair of C-beams respectively, underneath the solar table. In step 1090, the lander vehicle adjusts horizontal and/or vertical position of the pair of C-beams such that the torque tube is securely held onto one or more torque tube couplers attached to the pair of holding bars.

In step 1095, the solar table is disengaged from the mobile transport or the solar table trailer while the solar table is held by the lander vehicle to complete solar table transfer to the lander vehicle. The lander vehicle may retract the pair of C-beams to carry the solar table around more stably for installation. The height of the pair of C-beams may also be adjusted back to a default vertical position (e.g., the lowest position) or be kept at the vertical position when the lander vehicle fetches the solar table.

Besides real-time status monitoring, the one or more interactive interfaces may be configured to receive input to set up or adjust solar table production, delivery, and/or installation planning. Referring back to FIG. 4 and FIG. 5, when the digital installation field 420 is initialized, an authorized user may set up a production plan for solar tables in the installation field. One or more work fronts and flexible build patterns may be set up for the solar tables. For example, solar table representations in the digital installation field 420 may be grouped, e.g., by solar table types, and assigned to different production crews for manufacturing according to a planned production sequence. In another example, solar table representations in the digital installation field 420 may also be grouped, similarly to or differently from production grouping, for delivery and installation by different delivery and installation crews according to a planned delivery schedule and an installation schedule, respectively. Such production, delivery, and installation planning may be configured in a planning template or initialized to start production.

In one or more embodiments, the one or more interactive interfaces may be configured to aid a user in planning sequences of solar tables that are actually installable and/or automatically suggesting sequences based on predefined installation patterns. In other words, an automated installation manager (AIM) deployed in the server may be configured to propose an executable initial plan that prevents or excludes sequences being non-executable or requiring excessive times/efforts to accomplish.

In one or more embodiments, as the solar table production, delivery, and installation process goes on, it may be necessary to make some adjustments when one or more adjustment thresholds are met. For example, when a production of a certain type of solar tables is behind installation pace, an authorized user (e.g., a project manager) may change production priority at one or more assembly factories. In another example, the AIM may use Machine Learning (ML), Artificial intelligence (AI), or other algorithms to initiate a manufacturing sequence based on available material and resources, or to modify an existing build plan based on available resources and/or physical conditions on site, such as inaccessible areas or non-buildable piles, etc. In general, all manual inputs and modifications could be managed by an automated installation manager/software/algorithm.

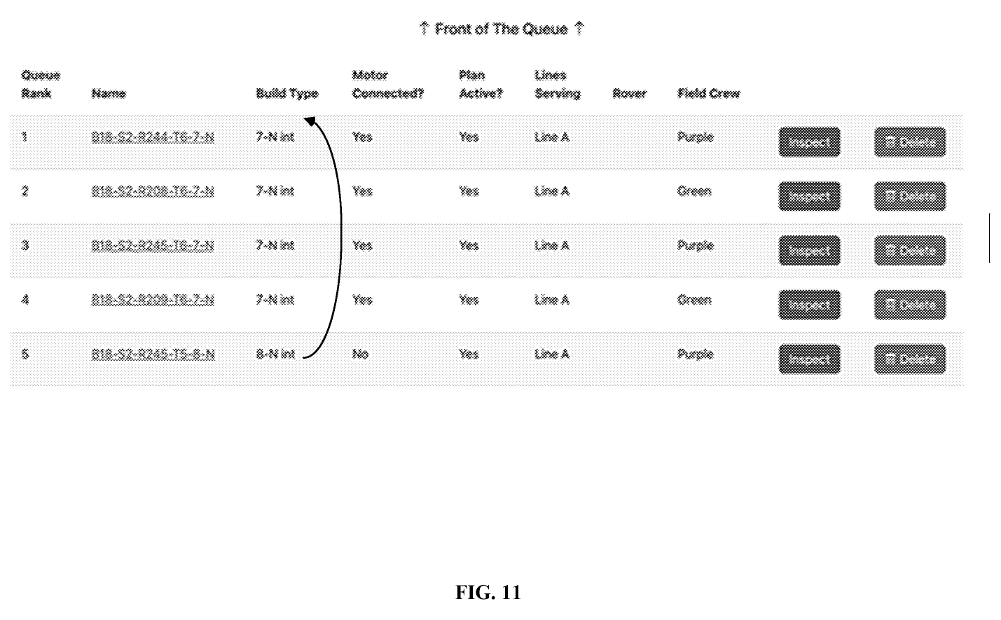

FIG. 11 depicts a configurable factory production interface with solar table manufacturing queue rank with various embodiments of the invention. When more solar tables of type “8-N int” are desired to match the installation pace, a user may move up the queue rank of such solar tables, e.g., by adjusting their rank from #5 to #1 (assuming that the “8-N int” table has a location to be installed on, otherwise such a change in queue will not be allowed). After the manufacturing queue rank is adjusted, the adjustment information is transmitted from the server to the centralized assembly factory for implementation. In another example, when one installation crew is behind schedule for installation tasks, the project manager may reassign some solar table assembling tasks queues for the installation crew to a different crew. In another embodiment, the reallocating of build/queue rank may also be initiated and performed by an AIM using ML, AI or other algorithms.

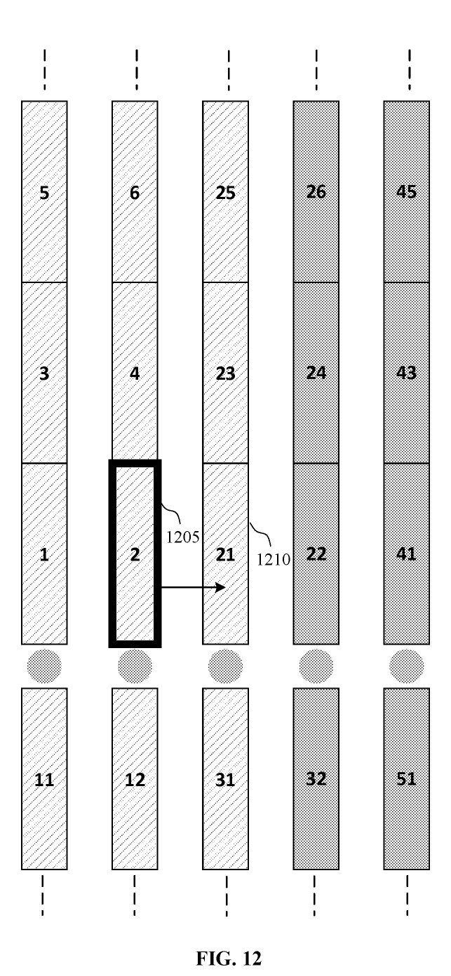

In one or more embodiments, when a traffic jam or another incident blocks access to an installation spot occurs, the project manager may adjust delivery plans for one or more mobile transports to deliver solar tables to other installation spots instead. Such adjustment may also be performed by an AIM as mentioned above. FIG. 12 graphically depicts an installation swap in an interactive interface for installation monitoring and control to adjust installation planning in accordance with various embodiments of the invention. In this interface, a first installation spot for a first solar table representation 1205 corresponding to a first solar table is blocked by the obstruction. A user may select the solar table representation 1205 and move it to overwrite a second solar table representation 1210 corresponding to a second solar table not yet being delivered or installed. In one or more embodiments, an AIM may automatically detect a traffic jam or any other obstruction or slowdown to a specific work front and modify the installation sequence to mitigate such slowdown.

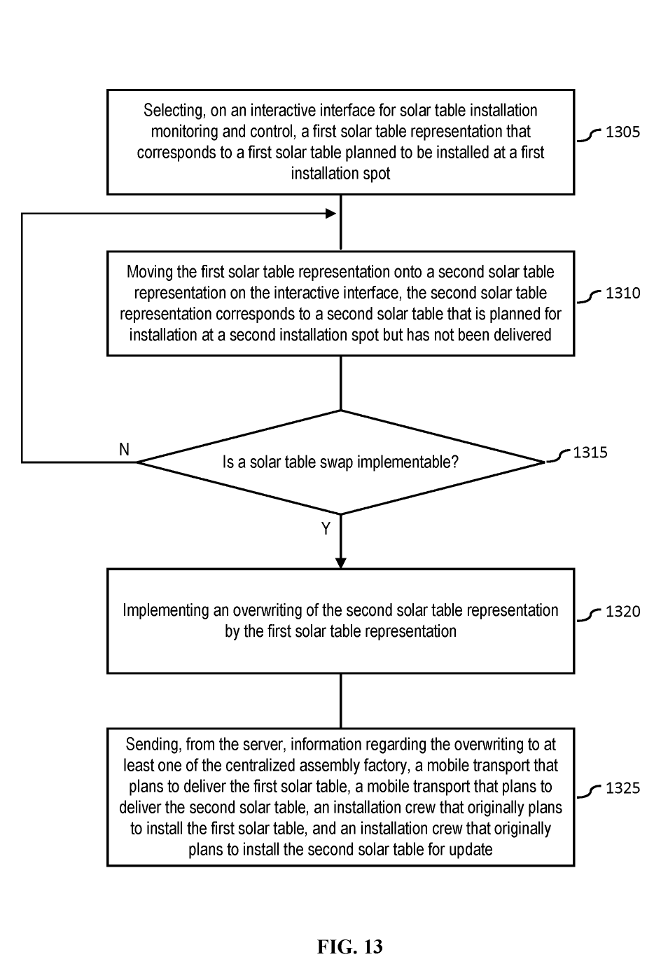

FIG. 13 depicts a process for solar table installation swap in accordance with various embodiments of the invention. In step 1305, a user selects, on an interactive interface for solar table installation monitoring and control (e.g., the digital installation field), a first solar table representation that corresponds to a first solar table planned to be installed at a first installation spot. Due to one or more circumstances, e.g., a traffic jam at the first installation spot, etc., the first solar table may not be desired for installation at the first installation spot as planned.

In step 1310, the user moves the first solar table representation onto a second solar table representation on the interactive interface. The second solar table representation corresponds to a second solar table that is planned for installation at a second installation spot but has not been delivered.

In step 1315, verification is made, at the server, to determine whether a solar table swap is implementable based on one or more criteria. For example, the server 340 may need to verify the first solar table and the second solar table have the same specification and thus are exchangeable. In another example, the server 340 may need to verify that a mobile transport delivering the second solar table is not within a predetermined range of the second installation spot. If the mobile transport has already been near the second installation spot, a swap would cause disarray and lower installation efficiency.

In response to the solar table swap being implementable, an overwriting of the second solar table representation by the first solar table representation is implemented in step 1320. In step 1325, the server sends information regarding the overwriting to at least one of: the centralized assembly factory, a mobile transport that is planned to deliver the first solar table, a mobile transport that is planned to deliver the second solar table, an installation crew who is assigned initially to install the first solar table, and an installation crew who is assigned initially to install the second solar table for update.

In response to the solar table swap not being implementable (e.g., solar table specifications not matching), the overwriting of the second solar table representation by the first solar table representation is disabled. The process goes back to step 1310 to check another second solar table representation.

### D. Computing System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smartphone, phablet, tablet, etc.), smartwatch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drive, solid state drive, or both), one or more network ports for communicating with external devices as well as various input and output (I/O) devices, such as a keyboard, mouse, touchscreen, stylus, microphone, camera, trackpad, display, etc. The computing system may also include one or more buses operable to transmit communications between the various hardware components.

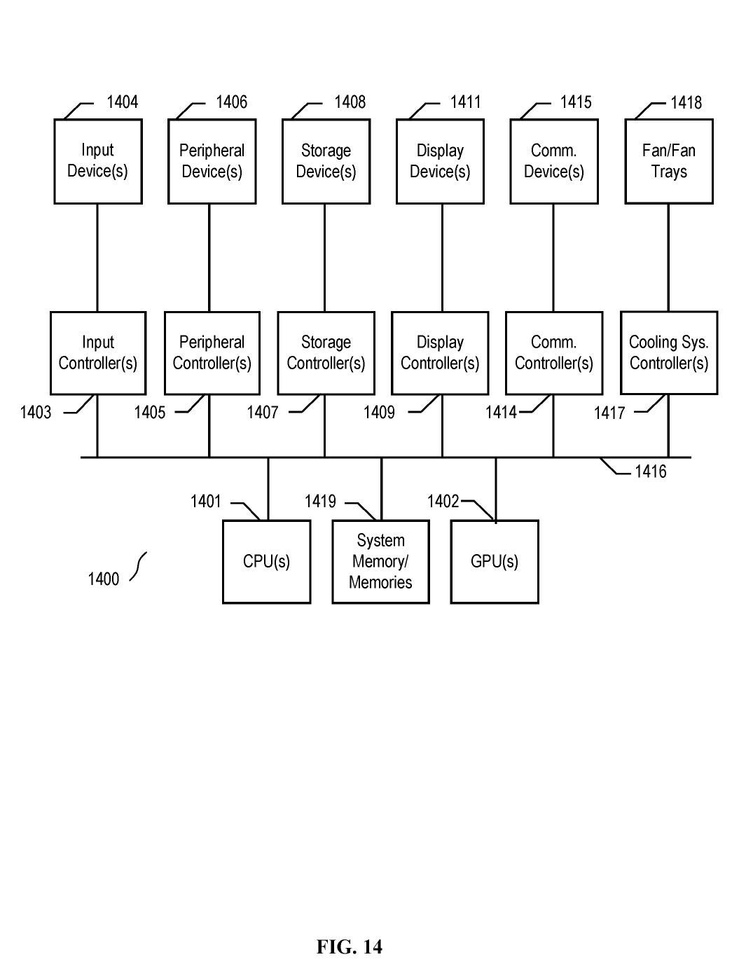

FIG. 14 depicts a simplified block diagram of an information handling system (or computing system), according to embodiments of the present disclosure. It will be understood that the functionalities shown for system 1400 may operate to support various embodiments of a computing system—although it shall be understood that a computing system may be differently configured and include different components, including having fewer or more components as depicted in FIG. 14.

As illustrated in FIG. 14, the computing system 1400 includes one or more CPUs 1401 that provide computing resources and control the computer. CPU 1401 may be implemented with a microprocessor or the like, and may also include one or more graphics processing units (GPU) 1402 and/or a floating-point coprocessor for mathematical computations. In one or more embodiments, one or more GPUs 1402 may be incorporated within the display controller 1409, such as part of a graphics card or cards. The system 1400 may also include a system memory 1419, which may comprise RAM, ROM, or both.

A number of controllers and peripheral devices may also be provided, as shown in FIG. 14. An input controller 1403 represents an interface to various input device(s) 1404. The computing system 1400 may also include a storage controller 1407 for interfacing with one or more storage devices 1408 each of which includes a storage medium such as magnetic tape or disk, or an optical medium that might be used to record programs of instructions for operating systems, utilities, and applications, which may include embodiments of programs that implement various aspects of the present disclosure. Storage device(s) 1408 may also be used to store processed data or data to be processed in accordance with the disclosure. The system 1400 may also include a display controller 1409 for providing an interface to a display device 1411, which may be a cathode ray tube (CRT) display, a thin film transistor (TFT) display, organic light-emitting diode, electroluminescent panel, plasma panel, or any other type of display. The computing system 1400 may also include one or more peripheral controllers or interfaces 1405 for one or more peripherals 1406. Examples of peripherals may include one or more printers, scanners, input devices, output devices, sensors, and the like. A communications controller 1414 may interface with one or more communication devices 1415, which enables the system 1400 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 1400 comprises one or more fans or fan trays 1418 and a cooling subsystem controller or controllers 1417 that monitors thermal temperature(s) of the system 1400 (or components thereof) and operates the fans/fan trays 1418 to help regulate the temperature.

In the illustrated system, all major system components may connect to a bus 1416, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

Aspects of the present disclosure may be encoded upon one or more non-transitory computer-readable media with instructions for one or more processors or processing units to cause steps to be performed. It shall be noted that non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magneto-optical media; and hardware devices that are specially configured to store or to store and execute program code, such as ASICs, PLDs, flash memory devices, other non-volatile memory devices (such as 3D XPoint-based devices), and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently, including having multiple dependencies, configurations, and combinations.

What is claimed is:

1. A method for construction management of a solar farm, the method comprising:
assembling, at a centralized assembly factory, a solar table that comprises a torque tube and one or more solar modules attached to the torque tube;
transporting, by a mobile transport or a solar table trailer, the solar table from the centralized assembly factory to or near a point of installation on an installation site;
transferring the solar table from the mobile transport or the solar table trailer to a lander vehicle; and
performing or facilitating, by the lander vehicle, installation of the solar table at the point of installation.

2. The method of claim 1, wherein the solar table is assembled according to a build order placed via a manufacturing execution system.

3. The method of claim 2, wherein the build order has a status that is trackable on the manufacturing execution system.

4. The method of claim 1, wherein the mobile transport is an autonomous driving vehicle.

5. The method of claim 1 further comprising:
driving the mobile transport or the solar table trailer back to the centralized factory to load another assembled solar table after transferring of the solar table is completed.

6. The method of claim 1, wherein transferring the solar table from the mobile transport or the solar table trailer to the lander vehicle comprising:
driving the lander vehicle in proximity to the mobile transport or the solar table trailer at or near the point of installation;
extending a pair of C-beams of the lander vehicle to place a pair of holding bars, supported by a pair of C-beams respectively, underneath the solar table;
adjusting horizontal and/or vertical position of the pair of C-beams such that the torque tube is securely held onto one or more torque tube couplers attached to the pair of holding bars; and
disengaging the solar table from the mobile transport or the solar table trailer while the solar table is held by the lander vehicle to complete solar table transfer to the lander vehicle.

7. The method of claim 6, wherein each C-beam has a lower beam arm that is rail to support a corresponding holding bar, the holding bar is slidable along the lower beam arm such that a yaw angle of the solar table is adjustable by the lander vehicle for installation.

8. The method of claim 1, wherein the lander vehicle is coordinated to move toward the point of installation in parallel to the mobile transport or the solar table trailer.

9. The method of claim 8, wherein coordination of the lander vehicle is implemented via a comprehensive interactive interface for solar table manufacturing, delivering, and installation monitoring and control.

10. The method of claim 9, wherein the mobile transport or the solar table trailer is represented as a transport representation on the comprehensive interactive interface, the lander vehicle is represented as a lander representation on the comprehensive interactive interface, the solar table is represented as a solar table representation on the comprehensive interactive interface.

11. The method of claim 10, wherein the solar table representation is associated to the transport representation when the solar table is loaded on the mobile transport or the solar table trailer; the solar table representation is disassociated from the transport representation and associated with the lander representation when the solar table is transferred to the lander vehicle.

12. The method of claim 10, wherein when a solar table is under transferring from the mobile transport or the solar table trailer to the lander vehicle, the transport representation and the lander representation are enclosed by a transferring representation on the comprehensive interactive interface to indicate an active solar table transferring process.

13. The method of claim 12, wherein the transferring representation is flashing during transferring of the solar table.

14. The method of claim 12, wherein the transport representation and the lander representation flash together to indicate an active transferring process.

15. A system for construction management of a solar farm, the method comprising:
a mobile transport or a solar table trailer that transports a solar table from a centralized assembly factory to or near a point of installation on an installation site, the solar table is assembled at the centralized assembly factory and comprises a torque tube and one or more solar modules attached to the torque tube; and
a lander vehicle that fetches the solar table from the mobile transport or the solar table trailer for solar table transferring, the lander vehicle performs or facilitates installation of the solar table at the point of installation.

16. The system of claim 15, wherein the lander vehicle is coordinated to move toward the point of installation in parallel to the mobile transport or the solar table trailer.

17. The system of claim 15, wherein the lander vehicle comprises:
a vehicle base;
an extendable arm having a proximal arm end pivotably attached to the vehicle base;
an extension beam coupled to a distal end of the extendable arm;
a pair C-beams coupled respectively to opposite ends of the extension beam, each C-beam has one tip supporting a holding bar that attaches one or more torque tube couplers.

18. The system of claim 17, wherein each torque tube coupler has an indentation that at least partially matches a cross-sectional shape of the torque tube for securely supporting the torque tube, each torque tube coupler is able to be actuated to facilitate the securement of the torque tube.

19. The system of claim 17, wherein the extension beam is coupled to the distal end of the extendable arm via a fork carriage, the fork carriage comprises a pair of forks and is pivotably connected to the distal end of the extendable arm.

20. The system of claim 15, wherein the mobile transport or the solar table trailer has similar structure for at least one of horizontal adjustability and vertical adjustability of the solar table to the lander vehicle.
